(19) United States
(12) Patent Application Publication
(10) Pub. No.: US 2009/0001735 A1
(43) Pub. Date: Jan. 1, 2009

(54) Mechanism for Securing the Handle of a Door or Window

(75) Inventors: Harald Neumayer, Vienna (AT); Walter Plank, Vienna (AT)

Correspondence Address: CHAPMAN AND CUTLER, 111 WEST MONROE STREET, CHICAGO, IL, 60603, US

(73) Assignee: EVVA-WERK Spezialerzeugung von Zylinder-und Sicherheitsschlossern Gesellschaft m.b.H. & Co. KG, Vienna (AT)

(21) Appl. No.: 12/224,194

(22) PCT Filed: Feb. 6, 2007
(86) PCT No.: PCT/AT2007/000056

§ 371 Date: Aug. 20, 2008

(30) Foreign Application Priority Data
Feb. 21, 2006 (AT) A 281/2006

(51) Int. Cl. E05B 3/00; E05B 1/00; F16D 1/00

(52) U.S. Cl. 292/350; 403/329; 292/348

(57) ABSTRACT

In a device for securing the handle or knob (9) of a door or window, comprising a locking element (18) that is disposed transversely to the axis of the handle or knob (9), a locking spring element (13) is disposed in a base part or a knob shield (1), the locking spring element (13) carries locking lugs (8, 7) that dip into radial openings (2, 6) of the base part or the knob shield (1) the locking element (18) interacts with the locking spring element (13) in such a manner that the locking spring element (13) is deformed when the locking element is displaced transversely to the axis of the handle or knob (9) and locking lugs (8, 7), disposed on the periphery of the locking spring element (13), disengage from or engage with recesses (10) on or in a part of the handle or knob (9) encircling the locking spring element (13) and the base part or the knob shield (1).

The invention relates to a device for securing a handle or knob of a door or window having a locking element disposed transversely to the axis of the handle or knob.

Door or window handles or knobs are known in various forms. In the configuration as a knob, mostly rotationally symmetrical components are commonly used, which are configured in the form of a mushroom head or a pot-shaped structure symmetrical to the axis of rotation. However, door knobs can also be rigidly interlocked with a door and in principle, secured against twisting. In other cases, a lock or a latch is actuated by twisting the knob or pivoting the handle and a corresponding rotationally fixed connection to the actuating part of the lock or the latch must be ensured. The most frequently and commonly used configuration of such a connection consists in using a threaded pin which is fixed by means of an Allen key to a central part connected to the lock or on a rigid part connected to the door or the window. For this purpose, the threaded pin is screwed in and pressed on. Usually, the non-positive connection here is restricted to the end region of the threaded pin which is mostly configured as running to a point in order to apply appropriate forces. In the event of severe vibrations and frequent actuation however, such a fixing screw can also become loose so that the knob or the handle is initially displaceable in the axial direction before it can fall off or be removed. Such fixing screws are only suitable for the connection of configurations of a knob having a large diameter in the connecting plane when a plurality of such screws are arranged in a distributed manner over the circumference in order to achieve a certain measure of security. However, the assembly effort is increased considerably with such a plurality of screws.

The object of the invention is now to provide a device of the type specified initially by which means a rotationally secure fixing of a door handle or knob, secured against axial displacement, can be reliably achieved even when the fixing is to be made on parts of relatively large diameter such as is the case, for example, when using a knob shield, wherein the knob to be placed thereon then closes a cavity in which further components can be accommodated if desired.

In order to achieve this object, the device according to the invention substantially consists in that a locking spring element is disposed in a base part or a knob shield, that the locking spring element carries locking lugs that dip into radial openings of the base part or the knob shield and that the locking element interacts with the locking spring element in such a manner that the locking spring element is deformed when the locking element is displaced transversely to the axis of the handle or knob and locking lugs, disposed on the periphery of the locking spring element, disengage from or engage with recesses on or in a part of the handle or knob encircling the locking spring element and the base part or the knob shield.

Since a locking spring element is disposed in a base part or a knob shield which itself in turn cooperates with a locking element, by deforming such a locking spring it is possible to bring locking lugs disposed on such a locking spring out of engagement or into engagement with corresponding locking recesses on the inner periphery of the handle or knob to be connected. With an appropriate configuration of the spring locking element, it is sufficient to have a single locking element which can simultaneously bring into engagement or out of engagement a plurality of locking lugs. In this way, it can be ensured that this plurality of locking lugs distributed over the periphery can lock a knob or handle placed thereon even at large diameters so that it is rotationally fixed and also secured against axial withdrawal, wherein a plurality of locking lugs distributed over the periphery is simultaneously effective against withdrawal. Locking can be achieved in a simple manner by loosening the screw so that in the locking position merely the spring force prevents any axial displacement or pivoting. At the same time, this ensures that in the event of vibrations which could result in loosening of the locking element, the strength of the connection is in no way impaired.

In a particularly advantageous embodiment in this case, the locking element is configured as a screw, in particular a threaded pin. By screwing in such a screw, it is possible to suitably deform the locking spring element according to the invention to bring the locking lugs out of engagement. In this case, in an advantageous embodiment the locking spring element is configured as a radially slitted, substantially annular spring leaf and carries locking lugs or projections that dip into openings of the base part or the knob shield on the periphery on both sides of the radial slit, which lugs pivot inwards during radial compression of the leaf springs, wherein preferably on both sides of the point of application of the locking element on the periphery, the locking spring element has protruding locking lugs which dip into slits in the base body accommodating the locking element and by actuating the locking element, can be brought out of engagement with recesses of the handle or knob placed on the base part or the knob shield, which correspond to the locking lugs. The locking spring element therefore has corresponding locking lugs distributed over the circumference not only adjacent to the application of the locking element but also near to the free ends and therefore close to the slit following in the peripheral direction, whereby secure locking between the base part or the knob shield and the handle or knob is achieved simultaneously at several points on the circumference.

As has already been mentioned, the knob itself can hereby be configured, for example, as pot-shaped so that parts of an electronic key identification logic, for example, can be accommodated in a protected manner in the interior of such a knob in the cavity between the knob shield and knob.

In a particularly advantageous manner, the device is configured such that, the free ends of the locking spring element adjacent to the radial slit, which follow the locking lugs that dip into the openings of the base part or the knob shield are inwardly rounded or are configured as running inwards at an acute angle to the tangent to the spring leaf or are configured as having a smaller radius compared with the radius of the locking spring element. Such a configuration ensures that during screwing-in of the locking element, not only the locking lugs adjacent to the locking element are pressed out of engagement but also the free ends of the locking spring element adjacent to the radial slit are bent inwards in such a manner that the locking lugs arranged there are pivoted inwards and thus brought out of engagement. These end regions of the spring leaf configured as having a smaller radius compared with the radius of the locking spring element or running at an acute angle to the tangent run on an edge of an opening in the base part or the knob shield and in this way bring about the corresponding pivoting during a deformation of the spring.

In order to provide security against loss for the locking member and at the same time ensure that any potentially remaining play in the radial direction can be securely braced, the device is advantageously configured such that at its radially outer end the locking element has a diameter exceeding the inside width of the radial opening of the knob for the insertion of a screwdriver tool. During screwing-out of the locking element, the spring element is initially relieved, whereby the locking lugs pass through the corresponding openings in the base part or the knob shield and bring about the locking whereupon, as the locking element is screwed out further, the head of said element collides with the inner contour of the knob or handles since it cannot pass through the corresponding opening due to its dimensions. With appropriate turning of the screw, this collision results in locking against slight radial displacements if these were still possible.

The invention is explained in detail hereinafter with reference to an exemplary embodiment shown schematically in the drawings. In these

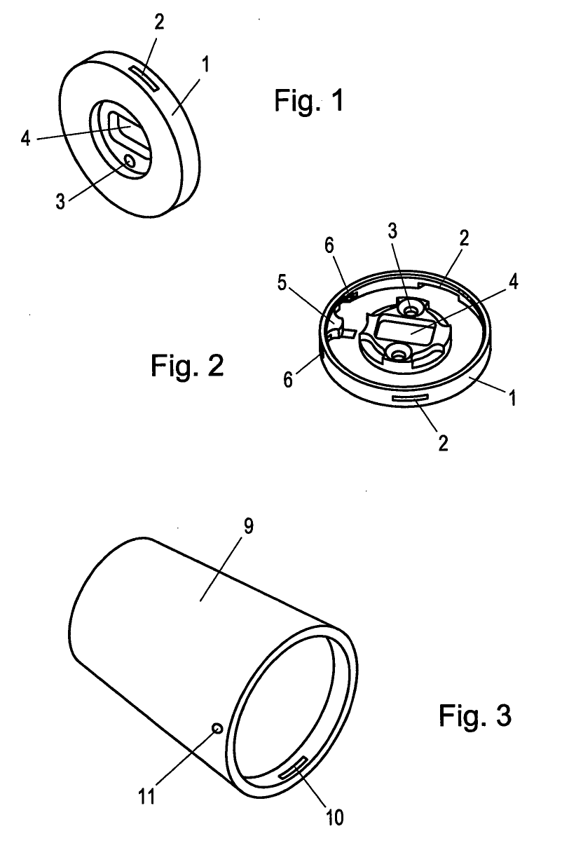

FIG. 1 shows a perspective view of a knob shield,

FIG. 2 shows the perspective view of the knob shield from FIG. 1 viewed from the inside,

FIG. 3 shows a knob which is to be connected rotationally fixedly and secured against axial displacement to the knob shield according to FIG. 1 or 2,

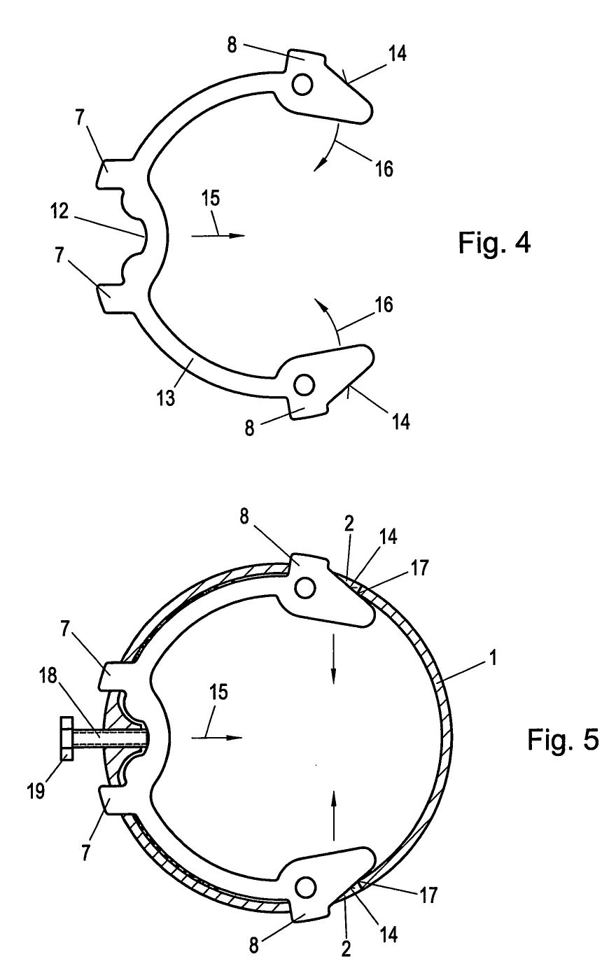

FIG. 4 shows an enlarged view of a locking spring element used for this purpose and

FIG. 5 shows the locking spring element according to FIG. 4 in a position inserted in a knob shield partly in cross-section.

FIG. 1 shows a knob shield 1 having openings 2 provided on its periphery. The knob shield 1 can be rigidly secured by means of screws, not shown, which pass through the holes 3, or connected to another component. A corresponding actuator which actuates a latch or a lock can be inserted in the polygonal receiving opening 4. However, corresponding shafts can also be passed through this opening.

A plurality of openings 2 can be seen in the diagram in FIG. 2. A fixing screw 18 can be inserted in the threaded component 5. The locking spring element 13 shown enlarged in FIG. 4 is not shown in FIG. 2. In addition to the openings 2, however, 6 designates slits adjacent to the component 5 for receiving the locking element 18 through which locking lugs can pass in the same way as through the openings 2, as are designated by 7 and 8 in FIG. 4

FIG. 3 shows a knob 9, whose inner periphery again has recesses 10 near the opening which must be brought into a correspondingly aligned position to the openings 2 or slits 6 of the knob shield 1. For this purpose, the opening 11 must be brought into an aligned position with the locking element so that the locking element 18 in the form of a screw or threaded pin can be appropriately screwed in or screwed out by inserting a screwdriver or Allen key.

As already mentioned, the locking spring element 13 shown enlarged in FIG. 4 bears locking lugs 7 and 8. In this case, the locking lugs 7 are arranged adjacent to the point of application 12 for the locking element 18. In the stress-relieved position of the spring leaf 13, the locking lugs 8 pass outwards through the openings 2, whereby the locking spring element or spring leaf 13 passes over the sloping surfaces 14 to abut against an edge of these openings 2. When turning the threaded pin 18 in the direction of the arrow 15, it is now immediately apparent that the two locking lugs 7 are also moved in the direction of the arrow 15 and are thus pulled back into the slit 6 of the knob shield 1. At the same time, the sloping surfaces 14 run onto the edges of the openings 2, whereby the locking lugs 8 are pivoted inwards in the direction of the arrow 16 and at the same time, pulled back into the openings 2 and no longer project over the outer periphery of the knob shield 1. At the same time, these locking lugs thus come out of engagement with the recess 10 on the inner periphery of the knob 9 shown in FIG. 3, whereby the same can be withdrawn.

The operating mode can be particularly clearly identified schematically in FIG. 5. In FIG. 5 the selected reference numerals from FIGS. 1 to 4 are retained, wherein in the stress-relieved position the ends of the openings 2 which cooperate with the sloping surfaces 14 of the free ends of the slitted locking spring element 13, are designated by 17. In FIG. 5 the locking member configured as a threaded pin is designated by 18 and has a front surface 19 which is larger than the inside diameter of the opening 11 for the actuating tool so that during unscrewing, the threaded pin 18 runs out on the inner periphery of the knob 9 and secures this against any movement in the radial direction. At the same time, the spring leaf 13 is stress-relieved in the direction opposite to that of the arrow 15 whereby the locking lugs 8 or 7 again dip through the wall of the knob shield 1 and are brought into a corresponding locking position with recesses on the inner periphery of the knob 9.

1-6. (canceled)

7. A device for securing a handle or knob of a door or window, comprising:
a locking element that is disposed transversely to an axis of the handle or knob (9), and
a locking spring element (13) disposed in a base part or a knob shield (1), wherein
the locking spring element carries sets of locking lugs (8, 8 and 7, 7) that dip respectively into corresponding sets of radial openings (2, 2 and 6, 6) formed in the base part or the knob shield (1),
the locking element interacts with the locking spring element (13) in such a manner that the locking spring element (13) is deformed when the locking element is displaced transversely to the axis of the handle or knob (9),
locking lugs of a first set (8, 8) of said sets of locking lugs are disposed on a periphery of the locking spring element (13), and
said first set of locking lugs (8, 8) disengage from or engage with recesses (10) formed in a part of the handle or knob (9) encircling the locking spring element (13) and the base part or the knob shield (1).

8. The device according to claim 7, wherein the locking element is a screw.

9. The device according to claim 7, wherein
the locking spring element (13) is a substantially annular spring leaf comprising a radial slit,
said spring leaf carries said first set of locking lugs (8, 8) that dip into a corresponding first set (2, 2) of the radial openings of the base part or knob shield (1) on the periphery of the spring leaf on both sides of the radial slit, and
said first set of locking lugs (8, 8) pivot inwards during radial compression of the spring leaf.

10. The device according to claim 7, wherein
on both sides of a point of application (12) of the locking element on the periphery of the locking spring element (13), the locking spring element (13) has disposed a second set (7, 7) of said sets of locking lugs that dip into a corresponding second set (6, 6) of the radial openings of the base part or knob shield (1),
said base part or knob shield (1) accommodates the locking element (18), and
by actuating the locking element (18), said second set (7, 7) of locking lugs are brought out of engagement with openings (6, 6) of the base part or knob shield (1).

11. The device according to claim 9, wherein free ends of the spring leaf that are positioned adjacent to the radial slit, and that follow the first set (8, 8) of locking lugs that dip into the corresponding first set (2, 2) of openings of the base part or knob shield (1), are inwardly rounded.

12. The device according to claim 7, wherein the locking element, at a radially outer end of the locking element, has a diameter exceeding an inside width of a radial opening (11) of the knob (9) shaped for insertion of a screwdriver tool.

13. The device according to claim 7, wherein the locking element is a threaded pin.

14. The device according to claim 9, wherein free ends of the spring leaf that are positioned adjacent to the radial slit, and that follow the first set (8, 8) of locking lugs that dip into the corresponding first set (2, 2) of openings of the base part or knob shield (1), are configured as running inwards at an acute angle to a tangent to the spring leaf.

15. The device according to claim 9, wherein free ends of the spring leaf that are positioned adjacent to the radial slit, and that follow the first set (8, 8) of locking lugs that dip into the corresponding first set (2, 2) of openings of the base part or knob shield (1), are configured as having a smaller radius compared with a radius of the spring leaf.

16. The device according to claim 10, wherein free ends of the spring leaf that are positioned adjacent to the radial slit, and that follow the first set (8, 8) of locking lugs that dip into the corresponding first set (2, 2) of openings of the base part or knob shield (1), are inwardly rounded.

17. The device according to claim 10, wherein free ends of the spring leaf that are positioned adjacent to the radial slit, and that follow the first set (8, 8) of locking lugs that dip into the corresponding first set (2, 2) of openings of the base part or knob shield (1), are configured as running inwards at an acute angle to a tangent to the spring leaf.

18. The device according to claim 10, wherein free ends of the spring leaf that are positioned adjacent to the radial slit, and that follow the first set (8, 8) of locking lugs that dip into the corresponding first set (2, 2) of openings of the base part or knob shield (1), are configured as having a smaller radius compared with a radius of the spring leaf.

19. The device according to claim 8, wherein
on both sides of a point of application (12) of the locking element on the periphery of the locking spring element (13), the locking spring element (13) has disposed a second set (7, 7) of said sets of locking lugs that dip into a corresponding second set (6, 6) of the radial openings of the base part or knob shield (1),
said base part or knob shield (1) accommodates the locking element (18), and
by actuating the locking element (18), said second set (7, 7) of locking lugs are brought out of engagement with openings (6, 6) of the base part or knob shield (1).

20. The device according to claim 9, wherein
on both sides of a point of application (12) of the locking element on the periphery of the locking spring element (13), the locking spring element (13) has disposed a second set (7, 7) of said sets of locking lugs that dip into a corresponding second set (6, 6) of the radial openings of the base part or knob shield (1),
said base part or knob shield (1) accommodates the locking element (18), and
by actuating the locking element (18), said second set (7, 7) of locking lugs are brought out of engagement with openings (6, 6) of the base part or knob shield (1).

21. The device according to claim 8, wherein the locking element, at a radially outer end of the locking element, has a diameter exceeding an inside width of a radial opening (11) of the knob (9) shaped for insertion of a screwdriver tool.

22. The device according to claim 9, wherein the locking element, at a radially outer end of the locking element, has a diameter exceeding an inside width of a radial opening (11) of the knob (9) shaped for insertion of a screwdriver tool.

23. The device according to claim 10, wherein the locking element, at a radially outer end of the locking element, has a diameter exceeding an inside width of a radial opening (11) of the knob (9) shaped for insertion of a screwdriver tool.

24. The device according to claim 11, wherein the locking element, at a radially outer end of the locking element, has a diameter exceeding an inside width of a radial opening (11) of the knob (9) shaped for insertion of a screwdriver tool.

25. The device according to claim 12, wherein the locking element, at a radially outer end of the locking element, has a diameter exceeding an inside width of a radial opening (11) of the knob (9) shaped for insertion of a screwdriver tool.

26. A device for securing a handle or knob of a door or window, comprising:
a locking element that is disposed transversely to an axis of the handle or knob (9), and
a locking spring element (13) disposed in a base part or a knob shield (1),
wherein
the locking spring element carries sets of locking lugs (8, 8 and 7, 7) that dip respectively into corresponding sets of radial openings (2, 2 and 6, 6) formed in the base part or the knob shield (1),
the locking element interacts with the locking spring element (13) in such a manner that the locking spring element (13) is deformed when the locking element is displaced transversely to the axis of the handle or knob (9),
locking lugs of a first set (8, 8) of said sets of locking lugs are disposed on a periphery of the locking spring element (13),
said first set of locking lugs (8, 8) disengage from or engage with recesses (10) formed in a part of the handle or knob (9) encircling the locking spring element (13) and the base part or the knob shield (1),
the locking element is a screw,
the locking spring element (13) is a substantially annular spring leaf comprising a radial slit,
said spring leaf carries said first set of locking lugs (8, 8) that dip into a corresponding first set (2, 2) of the radial openings of the base part or knob shield (1) on the periphery of the spring leaf on both sides of the radial slit,
said first set of locking lugs (8, 8) pivot inwards during radial compression of the spring leaf,
on both sides of a point of application (12) of the locking element on the periphery of the locking spring element (13), the locking spring element (13) has disposed a second set (7, 7) of said sets of locking lugs that dip into a corresponding second set (6, 6) of the radial openings of the base part or knob shield (1),
said base part or knob shield (1) accommodates the locking element (18),
by actuating the locking element (18), said second set (7, 7) of locking lugs are brought out of engagement with openings (6, 6) of the base part or knob shield (1),
free ends of the spring leaf that are positioned adjacent to the radial slit, and that follow the first set (8, 8) of locking lugs that dip into the corresponding first set (2, 2) of openings of the base part or knob shield (1), are inwardly rounded, and
the locking element, at a radially outer end of the locking element, has a diameter exceeding an inside width of a radial opening (11) of the knob (9) shaped for insertion of a screwdriver tool.
